(19) United States
(12) Patent Application Publication
(10) Pub. No.: US 2026/0342415 A1
(43) Pub. Date: Oct. 29, 2026

(54) BEAM REPORT REPORTING METHOD AND APPARATUS, BEAM REPORT RECEIVING METHOD AND APPARATUS, AND STORAGE MEDIUM

(71) Applicant: Beijing Xiaomi Mobile Software Co., Ltd., Beijing (CN)

(72) Inventor: Mingju LI, Beijing (CN)

(73) Assignee: Beijing Xiaomi Mobile Software Co., Ltd., Beijing (CN)

(21) Appl. No.: 19/099,242

(22) PCT Filed: Aug. 2, 2022
(86) PCT No.: PCT/CN2022/109732

§ 371 Date: Jan. 28, 2025

(51) Int. Cl. H04B 7/06; H04L 41/14

(52) U.S. Cl. CPC H04B 7/06952; H04L 41/145

(57) ABSTRACT

The present application relates to the field of mobile communications, and discloses a beam report reporting method and apparatus, a beam report receiving method and apparatus, and a storage medium. The method comprises: a terminal sends a beam report to a network device, wherein the beam report comprises beam information corresponding to M time instances, and M is a positive integer. The present application provides a solution for reporting beam information corresponding to time instances, and beam information corresponding to M time instances may be understood as beam information corresponding to M time instances determined by a terminal; the terminal can report the beam information of the M time instances to a network device by means of a beam report, that is, the terminal can report the beam information of a plurality of time instances simultaneously, so that the limitation that only the beam measurement result of one time instance can be reported is broken, and the communication reliability is thus ensured.

### TECHNICAL FIELD

The present disclosure relates to the field of mobile communication, and more particularly, to a beam report reporting method and apparatus, a beam report receiving method and apparatus, and a storage medium.

### BACKGROUND

In mobile communication systems, a network device configures a set of reference signal resources used for beam measurement for terminals, so that a terminal performs beam measurement based on the set of reference signal resources, and then reports the beam measurement results to a network device.

Specifically, the terminal measures the beam measurement results of each time instance, and reports the beam report corresponding to that time instance at the corresponding reporting time. That is, in the traditional method, the terminal only supports that one beam report contains the beam report of one time instance.

However, in beam prediction-based methods, the terminal needs to predict the beam measurement results of one or more time instances according to the beam measurement results of a plurality of measured time instances. Therefore, there is an urgent need for a method that may simultaneously report the beam reports of more than one time instance.

### SUMMARY

The embodiments of the present disclosure provide a beam report reporting method and apparatus, a beam report receiving method and apparatus, and a storage medium, breaking through the limitation that the beam measurement result of one time instance may only be reported, thereby ensuring the reliability of communication. The technical solution is as follows:

According to a first aspect of the present disclosure, there is provided a beam report reporting method, the method executed by a terminal, the method including:
sending a beam report to a network device, the beam report including beam information corresponding to M time instances, wherein M is a positive integer.

According to a second aspect of the present disclosure, there is provided a beam report receiving method, the method executed by a network device, the method including:
receiving a beam report sent by a terminal, the beam report including beam information corresponding to M time instances, wherein M is a positive integer.

According to a third aspect of the present disclosure, there is provided a beam report reporting apparatus, including:
sending module, configured to send a beam report to a network device, the beam report including beam information corresponding to M time instances, wherein M is a positive integer.

According to a fourth aspect of the present disclosure, there is provided a beam report receiving apparatus, including:
receiving module, configured to receive a beam report sent by a terminal, the beam report including beam information corresponding to M time instances, wherein M is a positive integer.

According to a fifth aspect of the present disclosure, there is provided a terminal, including: a processor; a transceiver connected to the processor; a memory for storing execute executable instructions of the processor; where the processor is configured to load and execute executable instructions to implement a beam report reporting method or a beam report receiving method as described in the aspects above.

According to a sixth aspect of the present disclosure, there is provided a network device, including: a processor; a transceiver connected to the processor; a memory for storing execute executable instructions of the processor; where the processor is configured to load and execute executable instructions to implement a beam report reporting method or a beam report receiving method as described in the aspects above.

According to a seventh aspect of the present disclosure, there is provided a communication system, including a terminal and a network device, the terminal used to implement a beam report reporting method as described in the first aspect above, the network device used to implement a beam report receiving method as described in the second aspect above.

According to an eighth aspect of the present disclosure, there is provided a computer-readable storage medium, executable program codes being stored on the readable storage medium, the executable program codes being loaded and executed to implement a beam report reporting method or a beam report receiving method as described in the aspects above.

According to a nineth aspect of the present disclosure, there is provided a chip, the chip including programmable logic circuits and/or program instructions, when the chip is run on a terminal or a network device, used to implement a beam report reporting method or a beam report receiving method as described in the aspects above.

According to a tenth aspect of the present disclosure, there is provided a computer program product, and when the computer program product is executed by a processer of a terminal or a network device, it is used to implement a beam report reporting method or a beam report receiving method as described in the aspects above.

The present disclosure provides a solution for reporting beam information corresponding to time instances, where the beam information corresponding to M time instances may be understood as the beam information determined by the terminal for the M time instances. The terminal may report the beam information of the M time instances to the network device through a beam report. That is to say, the terminal can simultaneously report the beam information of more than one time instance, breaking through the limitation of only being able to report the beam measurement result of one time instance, thereby ensuring the reliability of communication.

### BRIEF DESCRIPTION OF THE DRAWINGS

To more clearly illustrate the technical solutions in the embodiments of the present disclosure, a brief introduction to the accompanying drawings needed in the description of the embodiments will be provided below. It is obvious that the accompanying drawings described below are only some embodiments of the present disclosure. For those skilled in the art, other drawings can be obtained without creative labor based on these drawings.

FIG. 1 is a diagram showing a relationship between a historical period and a prediction period provided by an exemplary embodiment of the present disclosure;

FIG. 2 is another diagram showing a relationship between a historical period and a prediction period provided by an exemplary embodiment of the present disclosure;

FIG. 3 is a block diagram showing a communication system provided by an exemplary embodiment of the present disclosure;

FIG. 4 is a flow diagram showing a beam report reporting method provided by an exemplary embodiment of the present disclosure;

FIG. 5 is a flow diagram showing a method for indicating a numerical value provided by an exemplary embodiment of the present disclosure;

FIG. 6 is a flow diagram showing a method for indicating a numerical value provided by an exemplary embodiment of the present disclosure;

FIG. 7 is a flow diagram showing a beam report reporting method provided by an exemplary embodiment of the present disclosure;

FIG. 8 is a flow diagram showing a beam report receiving method provided by an exemplary embodiment of the present disclosure;

FIG. 9 is a block diagram showing a beam report reporting apparatus provided by an exemplary embodiment of the present disclosure;

FIG. 10 is a block diagram showing another beam report reporting apparatus provided by an exemplary embodiment of the present disclosure;

FIG. 11 is a block diagram showing a beam report receiving apparatus provided by an exemplary embodiment of the present disclosure;

FIG. 12 is a block diagram showing another beam report receiving apparatus provided by an exemplary embodiment of the present disclosure;

FIG. 13 is a schematic diagram showing a structure of a communication device provided by an exemplary embodiment of the present disclosure.

### DETAILED DESCRIPTION

To make the purpose, technical solutions and advantages of the present disclosure clearer, a further detailed description of the implementation of the present disclosure will be made in combination with the accompanying drawings below.

Here, the exemplary embodiments will be described in detail, and their examples are illustrated in the accompanying drawings. When referring to the drawings below, unless otherwise indicated, the same numbers in different drawings represent the same or similar elements. The embodiments described in the following exemplary embodiments do not represent all the embodiments consistent with the present disclosure. On the contrary, they are merely examples of apparatuses and methods consistent with some aspects of the present disclosure as detailed in the attached claims.

The terms used in the present disclosure are merely for the purpose of describing specific embodiments and are not intended to limit the present disclosure. The singular forms of “a”, “an” and “the” used in the present disclosure and the appended claims are also intended to include the plural forms, unless the context clearly indicates otherwise. It should also be understood that the term “and/or” used herein refers to and encompasses any and all possible combinations of one or more of the associated listed items.

It should be understood that although the terms “first”, “second”, “third”, etc. may be used in the present disclosure to describe various information, such information should not be limited to these terms. These terms are only used to distinguish information of the same type from each other. For example, without departing from the scope of the present disclosure, the “first information” may also be referred to as “second information”, and similarly, the “second information” may also be referred to as “first information”. Depending on the context, for instance, the word “if” used herein may be interpreted as “while”, “when” , or “in response to determining”.

It should be noted that the information (including but not limited to user device information, user personal information, etc.), data (including but not limited to data for analysis, stored data, displayed data, etc.) and signals involved in the present disclosure are all authorized by the users or fully authorized by all parties, and the collection, use and processing of relevant data need to comply with the relevant laws, regulations and standards of the relevant countries and regions.

First, a brief introduction is provided for several terms used in the embodiments of the present disclosure.

Beam prediction model: A terminal may measure the beam quality information of previous N historical periods, that is, the historical periods are the periods for which the terminal has already measured the beam quality information, and input the beam quality information of the N historical periods into the beam prediction model. According to this beam prediction model, the beam quality information of future F prediction periods will be determined. That is, the terminal does not need to measure the beam quality information of the F prediction periods but can predict the beam quality information through the beam prediction model, where F is a positive integer.

Herein there are two types of relationships between N and F in the embodiments of the present disclosure.

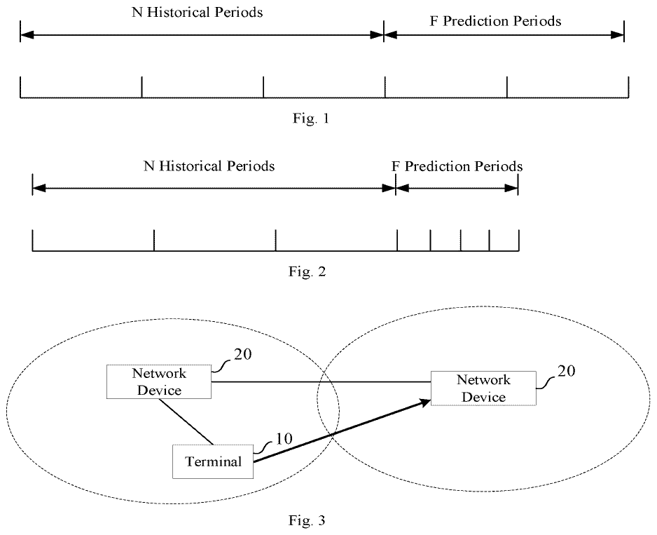

The first type: The length of the historical period is the same as that of the prediction period, and the F prediction periods come after the N historical periods. For example, as shown in FIG. 1, the length of the historical period and the length of the prediction period are the same.

The second type: The length of the historical period is greater than that of the prediction period, meaning that the length of the historical period includes a plurality of lengths of the prediction period.

For instance, as shown in FIG. 2, length of the historical period is greater than that of the prediction period, meaning that the length of the historical period includes a plurality of lengths of the prediction period. That is, the period corresponding to the historical period is a long period, while the period corresponding to the prediction period is a short period. It can also be understood that if the terminal is moving at high speed, the beam may switch faster, so it is necessary to predict the beam changes at shorter intervals. In this case, the beam quality information of the (N+1)th long period is still reported, but the beam quality information of F short periods within the (N+1)th long period can be predicted by the beam prediction model.

The following provides an explanation of the application scenarios of the present disclosure.

FIG. 3 is a block diagram showing a communication system provided by an exemplary embodiment of the present disclosure. The communication system may include: terminal 10 and network 20.

The number of terminal 10 is usually multiple. One or more terminals 10 may be distributed within the cell managed by each network device 20. Terminals 10 may include various handheld devices, vehicle-mounted devices, wearable devices, computing devices with wireless communication functions, or other processing devices connected to a wireless modem, as well as various forms of User Equipment (UE), Mobile Station (MS), etc. For ease of description, in the embodiments of the present disclosure, the above-mentioned devices are collectively referred to as terminals.

Network device 20 is a device deployed in the access network to provide wireless communication functions for terminal 10. For ease of description, in the embodiments of the present disclosure, the abovementioned device providing wireless communication functions for terminal 10 is collectively referred to as the network device. Network device 20 and terminal 10 may establish a connection through the air interface, and communicate through this connection, including the interaction of signaling and data. There may be a plurality of network devices 20, and two adjacent network devices 20 may also communicate through wired or wireless means. Terminal 10 may send beam reports among different network devices 20, that is, establish connections with different network devices 20.

The network device 20 may include various forms of macro base stations, micro base stations, relay stations, access points, etc. In systems employing different wireless access technologies, the names of devices with network device functions may vary. For example, in a 5G NR (New Radio) system, it is called a gNodeB or gNB. As communication technologies evolve, the name “network device” may change.

The “5G NR system” in the embodiments of the present disclosure may also be referred to as a 5G system or an NR system, but those skilled in the art can understand its meaning. The technical solutions described in the embodiments of the present disclosure may be applied to 5G NR systems and may also be applied to the subsequent evolution systems of 5G NR systems.

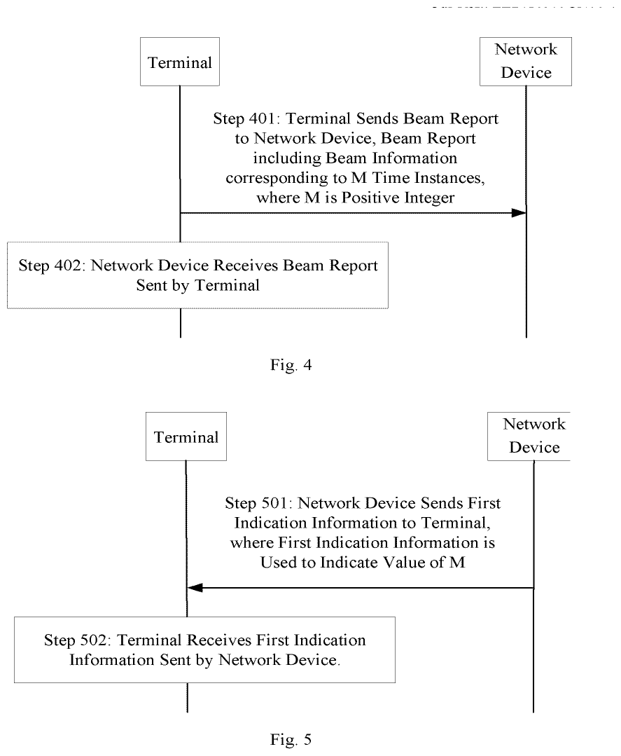

FIG. 4 is a flow diagram showing a beam report reporting method provided by an exemplary embodiment of the present disclosure. This method may be applied, for example, to the terminal and the network devices as shown in FIG. 3. This method includes at least part of the following contents:
Step 401: the terminal sends a beam report to the network device, the beam report including beam information corresponding to M time instances, where M is a positive integer.
Step 402: the network device receives the beam report sent by the terminal.

Herein the time instance may be referred to as “time instance”. In some embodiments, the time instance may also be understood as a time point or a time period, that is to say, the beam report includes beam information corresponding to M time points or time periods. The beam report refers to the information corresponding to the beam determined by the terminal, and then the terminal informs the network device of the corresponding beam information through the beam report.

The beam information corresponding to M time instances refers to the beam information of the beam corresponding to the M time instances determined by the terminal.

In the embodiments of the present disclosure, after the terminal determines the beam information corresponding to M time instances, it may carry the beam information in the beam report and send the beam report to the network device. Then, the network device may determine the beam information according to the beam report.

In some embodiments, the beam information corresponding to M time instances includes the beam information obtained by the terminal through beam measurement and/or beam information predicted based on a beam prediction model. The beam information predicted based on a beam prediction model is determined by the terminal based on beam information obtained through the beam measurement and the beam prediction model.

Optionally, the beam information included in the M time instances includes any of the following situations:
(1) The beam information corresponding to each of the M time instances includes the beam information obtained by the terminal through beam measurement.
(2) The beam information corresponding to each of the M time instances includes the beam information predicted by the terminal based on the beam prediction model.
(3) The beam information corresponding to at least one of the M time instances includes the beam information obtained by the terminal through beam measurement, and the beam information corresponding to at least another time instance of the M time instances includes the beam information predicted based on the beam prediction model.

It should be noted that if the terminal needs to perform beam measurement, it is needed that the network device configures reference signal measurement resources for the terminal in advance, and then the terminal conducts beam measurement based on the configured reference signal measurement resources to obtain beam information.

Optionally, the network device sends configuration information to the terminal. This configuration information is used to configure the reference signal measurement resources for beam measurement. The terminal receives this configuration information and may determine the reference signal measurement resources for beam measurement, and then perform beam measurement based on these reference signal measurement resources.

It should be noted that the steps executed by the terminal in the embodiments of the present disclosure may form a new embodiment independently, and the steps executed by the network device may also form a new embodiment independently. The present disclosure is not limited.

The present disclosure provides a solution for reporting beam information corresponding to a plurality of time instances, and the beam information corresponding to M time instances may be understood as the beam information determined by the terminal for the M time instances. The terminal may report the beam information of the M time instances to the network device through a beam report. That is to say, the terminal can simultaneously report the beam information of more than one time instance, breaking through the limitation of only being able to report the beam measurement result of one time instance, thereby ensuring the reliability of communication.

The embodiment shown in FIG. 4 explains the beam information corresponding to M time instances reported by the terminal. In the embodiments of the present disclosure, each time instance among the M time instances corresponds to a time period, or the interval between every two adjacent time instances among the M time instances is a preset interval.

In some embodiments, if each of the M time instances corresponds to a time period, and the length of each time period is the same, that is to say, the M time instances cycle at the same period.

In some embodiments, if each of the M time instances corresponds to a time period, and the length of each time period is different, for example, there are two length values of the time periods, one corresponding to a long period and the other corresponding to a short period.

In some other embodiments, if the interval between each two adjacent time instances among the M time instances is a preset interval, where the preset interval contains only one preset interval value, that is to say, the time instances also cycle at the same period, and the interval between two adjacent time instances is the same preset interval.

In some other embodiments, if the interval between each two adjacent time instances among the M time instances is a preset interval, where the preset interval includes a plurality of preset interval values, such as preset interval 1 and preset interval 2, preset interval 1 corresponding to a long period and preset interval 2 corresponding to a short period.

For M time instances, the value of M is indicated by the network device, or it may also be indicated by the terminal. The following provides explanations for each indication situation.

The first type: The value of M is indicated by the network device. Referring to FIG. 5, FIG. 5 is a flow diagram showing a method for indicating a numerical value provided by an exemplary embodiment of the present disclosure. Exemplarily, it may be applied in the terminal and network device as shown in FIG. 3. This method includes at least some of the following contents:
Step 501: the network device sends the first indication information to the terminal, where this first indication information is used to indicate the value of M.
Step 502: the terminal receives the first indication information sent by the network device.

In the embodiments of the present disclosure, the network device may determine the value of M, and then indicate the value of M to the terminal through the first indication information. Then the terminal may report the beam information corresponding to M time instances to the network device according to the value of M.

In some embodiments, after the network device indicates the value of M, the time periods corresponding to the M time instances or the intervals between adjacent time instances among the M time instances may be determined in a plurality of ways. The following is an explanation of each determination way:

The first way: The time period corresponding to each of the M time instances is determined based on the historical time period, which is the time period during which the terminal conducts beam reporting.

In the embodiment of the present disclosure, there is a time period corresponding to each of the M time instances, and the terminal may perform beam reporting according to the historical time period. That is to say, the terminal may determine the historical time period, and then the terminal may determine the time period corresponding to each time instance based on the historical time period.

In some embodiments, the length of the period corresponding to each of the M time instances is the same as the length of the historical period. Optionally, in the embodiments of the present disclosure, it may also be understood that the cycle length of each time instance is the same as the cycle length corresponding to the historical period.

For example, as shown in FIG. 1, the length of the time period corresponding to each of the M time instances is the same as the length of each of the N historical time periods.

In some other embodiments, the length of the time period corresponding to each of the M time instances is less than the length of the historical period. That is to say, each historical period includes the period lengths corresponding to more than one time instances.

Optionally, the length of the time period corresponding to each time instance is the ratio of the length of the historical time period to M+1.

For example, as shown in FIG. 2, the length of the time period corresponding to each time instance is the ratio of the length of the historical time period to 4.

In some other embodiments, the length of the time period corresponding to each of the M time instances is greater than the length of the historical time period.

In some other embodiments, the length of the time period corresponding to X time instances among the M time instances is equal to the length of the historical time period, and the length of the time period corresponding to Y time instances among the M time instances is less than or greater than the length of the historical time period, where X+Y=M, and both X and Y are positive integers.

The second way: The preset interval between each two adjacent time instances is determined based on the historical interval, and the historical interval is the interval at which the terminal conducts beam reporting.

In the embodiment of the present disclosure, there is a preset interval corresponding to every two adjacent time instances among the M time instances, and the terminal may conduct beam measurement according to the historical interval. That is to say, the terminal may determine the historical interval, and then the terminal may determine the preset interval corresponding to each time instance based on the historical interval.

In some embodiments, the length of the preset interval corresponding to every two adjacent time instances among the M time instances is the same as the historical interval length.

For example, referring to FIG. 1, the length of the preset interval corresponding to every two adjacent time instances among the M time instances is the same as the length of each historical interval among the N historical intervals.

In other embodiments, the length of the preset interval corresponding to every two adjacent time instances among the M time instances is less than the historical interval length. That is to say, each historical interval length includes a plurality of preset interval lengths.

Optionally, each preset interval length is the ratio of the historical interval length to M+1.

For example, referring to FIG. 2, each historical interval length includes 4 preset interval lengths, that is to say, each preset interval length is the ratio of the historical interval length to 4.

In some other embodiments, the preset interval length corresponding to every two adjacent time instances among the M time instances is greater than the historical interval length.

In some other embodiments, the preset interval length corresponding to every two adjacent time instances among X time instances among the M time instances is equal to the historical interval length, and the preset interval length corresponding to each two adjacent time instances among Y time instances among the M time instances is less than or equal to the historical interval length, where X+Y=M, and both X and Y are positive integers.

The third way: The time period corresponding to each of the M time instances is determined based on the future time period, and the future time period is the time period during which the terminal conducts beam prediction.

In the embodiments of the present disclosure, the terminal may conduct beam prediction based on the beam information corresponding to the historical time period, thereby obtaining the predicted beam information, and the length of the time period corresponding to the predicted time instance may be determined based on the length of the future time period.

Optionally, the length of the future time period is set by the terminal, or by the network device, or agreed upon by the communication protocol.

In some embodiments, the length of the time period corresponding to each time instance is the same as the length of the future time period.

In some other embodiments, the length of the future time period includes the lengths of the time periods corresponding to a plurality of time instances.

Optionally, the length of the time period corresponding to each time instance is the ratio of the length of the future time period to the number of time instances.

In some other embodiments, the length of the time period corresponding to each time instance is greater than the length of the future time period.

The fourth way: The preset interval between every two adjacent time instances is determined based on the future interval, and the future interval is the interval at which the terminal performs beam prediction.

In the embodiment of the present disclosure, the terminal may perform beam prediction based on the beam information corresponding to the historical time period, and then obtain the predicted beam information. Moreover, the preset interval length corresponding to the predicted time instance may be determined based on the future interval length.

Optionally, the future interval length is set by the terminal, or by the network device, or agreed upon by the communication protocol.

In some embodiments, the preset interval length corresponding to each time instance is the same as the future interval length.

In other embodiments, the future interval length includes the preset interval lengths corresponding to a plurality of time instances.

In other embodiments, the preset interval length corresponding to each time instance is greater than the future interval length.

In the solutions provided in the embodiments of the present disclosure, the network device may indicate the value of M, and then the time period corresponding to the M time instances or the interval between adjacent time instances is determined by various ways, so that the terminal reports the beam report based on the determined time period corresponding to the M time instances or the interval between adjacent time instances, which improves the accuracy of reporting the beam report.

In some embodiments, the terminal needs to report its own capabilities to the network device, and then the network device may determine the value of M indicated by the first indication information based on the maximum number of time instances supported by the terminal.

Herein the terminal sends terminal capability information to the network device, and this terminal capability information indicates the maximum number L of time instances included in the beam report supported by the terminal, and M is not greater than L.

In the embodiment of the present disclosure, the terminal indicates the maximum number L of time instances included in the beam report supported by the terminal through the sent terminal capability information. After the network device receives the L, the network device will determine an M that is not greater than L, and then send indication information for indicating the M to the terminal.

In the solutions provided in the embodiments of the present disclosure, the terminal reports to the network device the maximum number of time instances included in the beam report supported by itself, so that the network device may determine M according to the capability of the terminal, that is, the determined value of M is not greater than L, ensuring the accuracy of the value of M indicated by the network device, and further ensuring the reliability of the beam report reported by the terminal.

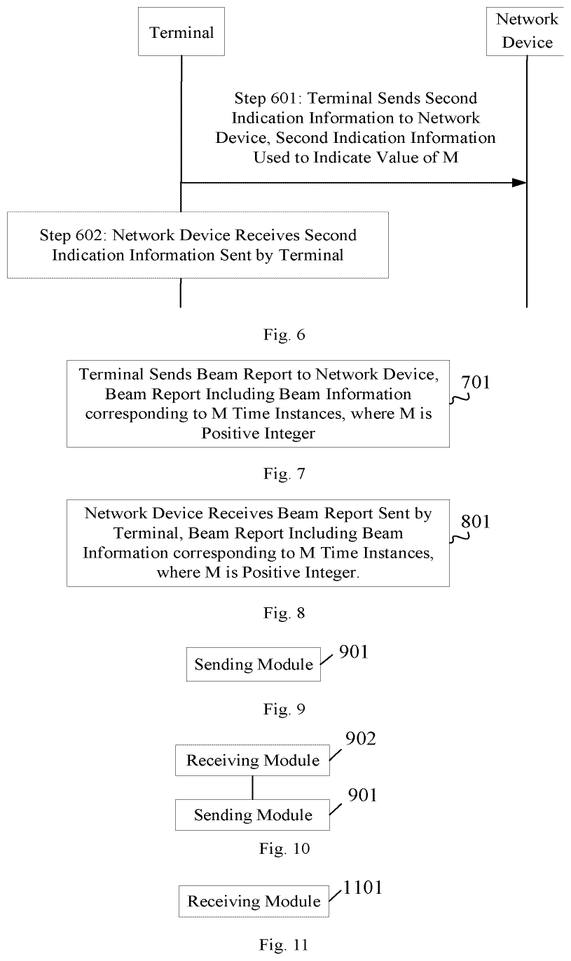

The second type: The value of M is indicated by the terminal. Referring to FIG. 6, FIG. 6 is a flow diagram showing a method for indicating a numerical value provided by an exemplary embodiment of the present disclosure. Exemplarily, it may be applied in the terminal and network device as shown in FIG. 3. This method includes at least some of the following contents:
Step 601: the terminal sends the second indication information to the network device, where this second indication information is used to indicate the value of M.
Step 602: the network device receives the second indication information sent by the terminal.

In the embodiments of the present disclosure, the terminal may also determine the value of M by itself, and then the terminal may indicate the determined value of M to the network device through the second indication information.

In some embodiments, this second indication information is determined by the terminal based on the obtained beam information of different time instances.

In the embodiments of the present disclosure, the terminal may obtain the beam information of different time instances and determine the value of M according to the obtained beam information. Further, this second indication information also includes the identification of the time instance to indicate which time instances corresponding to the beam information reported by the terminal.

Optionally, the terminal determines the value of M to be reported based on whether the obtained beam information of different time instances is similar.

Optionally, under the circumstance of the K beams corresponding to the strongest beam quality included in the beam information of different time instances obtained by the terminal are the same, it is determined that the beam information of different time instances is similar. Conversely, it is determined that the beam information of different time instances is not similar.

For example, the terminal may predict the beam information of 4 time instances. If it is determined that the beam information of two adjacent times is approximately the same, only the beam information of 2 time instances may be reported, and it is indicated which two time instances these two time instances correspond to.

In some embodiments, the network device also indicates to the terminal the maximum number of time instances reported by the terminal. Herein the number of time instances reported by the terminal is not greater than the maximum number.

Optionally, the terminal determines the value of M to be reported based on whether the obtained beam information of different time instances is similar.

Optionally, under the circumstance of the K beams corresponding to the strongest beam quality at least included in the beam information of different time instances obtained by the terminal are the same, it is determined that the beam information of different time instances is similar. Conversely, it is determined that the beam information of different time instances is not similar.

For example, the terminal determines that the X time instances correspond to time instance #1, time instance #2, time instance #3, and time instance #4. The terminal finds that the beam information of time instance #1 and time instance #2 is approximately the same, and the beam information of time instance #3 and time instance #4 is approximately the same. Then, only the beam information of time instance #1 and time instance #3 may be reported. Time instance #2 continues to use the beam information of time instance #1, and time instance #4 continues to use the beam information of time instance #3.

In some embodiments, after the terminal determines the value of M, the time periods corresponding to the M time instances or the intervals between adjacent time instances among the M time instances may be determined in a plurality of ways. The following is an explanation of each determination way:

The first way: The time period corresponding to each of the M time instances is determined based on the historical time period, which is the time period during which the terminal conducts beam measurement.

In the embodiment of the present disclosure, there is a time period corresponding to each of the M time instances, and the terminal may perform beam measurement according to the historical time period. That is to say, the terminal may determine the historical time period, and then the terminal may determine the time period corresponding to each time instance based on the historical time period.

In some embodiments, the length of the period corresponding to each of the M time instances is the same as the length of the historical period. Optionally, in the embodiments of the present disclosure, it may also be understood that the cycle length of each time instance is the same as the cycle length corresponding to the historical period.

For example, as shown in FIG. 1, the length of the time period corresponding to each of the M time instances is the same as the length of each of the N historical time periods.

In some other embodiments, the length of the time period corresponding to each of the M time instances is less than the length of the historical period. That is to say, each historical period includes the period lengths corresponding to more than one time instances.

Optionally, the length of the time period corresponding to each time instance is the ratio of the length of the historical time period to M+1.

For example, as shown in FIG. 2, the length of the time period corresponding to each time instance is the ratio of the length of the historical time period to 4.

In some other embodiments, the length of the time period corresponding to each of the M time instances is greater than the length of the historical time period.

In some other embodiments, the length of the time period corresponding to X time instances among the M time instances is equal to the length of the historical time period, and the length of the time period corresponding to Y time instances among the M time instances is less than or greater than the length of the historical time period, where X+Y=M, and both X and Y are positive integers.

The second way: The preset interval between each two adjacent time instances is determined based on the historical interval, and the historical interval is the interval at which the terminal conducts beam reporting.

In the embodiment of the present disclosure, there is a preset interval corresponding to every two adjacent time instances among the M time instances, and the terminal may conduct beam measurement according to the historical interval. That is to say, the terminal may determine the historical interval, and then the terminal may determine the preset interval corresponding to each time instance based on the historical interval.

In some embodiments, the length of the preset interval corresponding to every two adjacent time instances among the M time instances is the same as the historical interval length.

For example, referring to FIG. 1, the length of the preset interval corresponding to every two adjacent time instances among the M time instances is the same as the length of each historical interval among the N historical intervals.

In some other embodiments, the length of the preset interval corresponding to every two adjacent time instances among the M time instances is less than the historical interval length. That is to say, each historical interval length includes a plurality of preset interval lengths.

Optionally, each preset interval length is the ratio of the historical interval length to M+1.

For example, referring to FIG. 2, each historical interval length includes 4 preset interval lengths, that is to say, each preset interval length is the ratio of the historical interval length to 4.

In some other embodiments, the preset interval length corresponding to every two adjacent time instances among the M time instances is greater than the historical interval length.

In some other embodiments, the preset interval length corresponding to every two adjacent time instances among X time instances among the M time instances is equal to the historical interval length, and the preset interval length corresponding to each two adjacent time instances among Y time instances among the M time instances is less than or equal to the historical interval length, where X+Y=M, and both X and Y are positive integers.

The third way: The time period corresponding to each of the M time instances is determined based on the future time period, and the future time period is the time period during which the terminal conducts beam prediction.

In the embodiments of the present disclosure, the terminal may conduct beam prediction based on the beam information corresponding to the historical time period, thereby obtaining the predicted beam information, and the length of the time period corresponding to the predicted time instance may be determined based on the length of the future time period.

Optionally, the length of the future time period is set by the terminal, or by the network device, or agreed upon by the communication protocol.

In some embodiments, the length of the time period corresponding to each time instance is the same as the length of the future time period.

In some other embodiments, the length of the future time period includes the lengths of the time periods corresponding to a plurality of time instances.

Optionally, the length of the time period corresponding to each time instance is the ratio of the length of the future time period to the number of time instances.

In some other embodiments, the length of the time period corresponding to each time instance is greater than the length of the future time period.

The fourth way: The preset interval between every two adjacent time instances is determined based on the future interval, and the future interval is the interval at which the terminal performs beam prediction.

In the embodiment of the present disclosure, the terminal may perform beam prediction based on the beam information corresponding to the historical time period, and then obtain the predicted beam information. Moreover, the preset interval length corresponding to the predicted time instance may be determined based on the future interval length.

Optionally, the future interval length is set by the terminal, or by the network device, or agreed upon by the communication protocol.

In some embodiments, the preset interval length corresponding to each time instance is the same as the future interval length.

In other embodiments, the future interval length includes the preset interval lengths corresponding to a plurality of time instances.

In other embodiments, the preset interval length corresponding to each time instance is greater than the future interval length.

In the solutions provided in the embodiments of the present disclosure, the network device may indicate the value of M, and then the time period corresponding to the M time instances or the interval between adjacent time instances is determined by various ways, so that the terminal reports the beam report based on the determined time period corresponding to the M time instances or the interval between adjacent time instances, which improves the accuracy of reporting the beam report.

On the basis that it is illustrated in the above-mentioned embodiments that the terminal reports the beam information corresponding to a plurality of time instances, the beam information is described.

In some embodiments, the beam information includes at least one of the following:
(1) reference signal indicator.

Herein the reference signal indicator is used to indicate the reference signal. In some embodiments, the reference signal indicator is represented by RS ID (Reference Signal indicator).

Optionally, the reference signal indicator includes a Synchronization PBCH block (SSB) resource indicator or a Channel State Information Reference Signal (CSI-RS) resource indicator.

(2) The beam quality corresponding to the reference signal indicator.

Herein the beam quality refers to the beam quality determined by the terminal based on the reference signal indicated through the reference signal indicator. In some embodiments, the beam quality includes at least one of Layer 1 (L1)-Reference Signal Received Power (RSRP) or L1-Signal to Interference plus Noise Ratio Received Power (SINR).

In some embodiments, if the beam information includes the beam quality corresponding to the reference signal indicator, the terminal may report the beam quality in different ways.

The first way of reporting: under the circumstance of the beam information including the beam quality corresponding to the reference signal indicator, the beam information includes absolute values of the M strongest beam qualities, where the M strongest beam qualities correspond one-to-one to the M time instances, the beam information further includes relative values of the other beam qualities except the strongest beam quality corresponding to the i-th time instance among the M time instances with respect to the strongest beam quality corresponding to the i-th time instance, where i takes integer values from 1 to M.

In the embodiments of the present disclosure, if the beam information reported by the terminal includes the beam quality corresponding to the reference signal indicator, the terminal may report the strongest beam qualities corresponding to the M time instances respectively, and then for each time instance, report the relative values of the other beam qualities except the strongest beam quality corresponding to the time instance with respect to the strongest beam quality.

For example, the M time instances include time instance A, time instance B, and time instance C. Time instance A corresponds to beam quality 1, beam quality 2, and beam quality 3, among which beam quality 1 is the strongest. Time instance B corresponds to beam quality 4, beam quality 5, and beam quality 6, among which beam quality 4 is the strongest. Time instance C corresponds to beam quality 7, beam quality 8, and beam quality 9, among which beam quality 7 is the strongest.

Then the terminal reports the absolute value of beam quality 1 corresponding to time instance A, the relative value of beam quality 2 with respect to beam quality 1, and the relative value of beam quality 3 with respect to beam quality 1, and reports the absolute value of beam quality 4 corresponding to time instance B, the relative value of beam quality 5 with respect to beam quality 4, and the relative value of beam quality 6 with respect to beam quality 4, and reports the absolute value of beam quality 7 corresponding to time instance C, the relative value of beam quality 8 with respect to beam quality 7, and the relative value of beam quality 9 with respect to beam quality 7.

The second way of reporting: under the circumstance of the beam information including beam quality corresponding to the reference signal indicator, the beam information includes an absolute value of one strongest beam quality, where the one strongest beam quality corresponds to the target time instance among the M time instances, the beam information further includes relative values of the other beam qualities except the strongest beam quality with respect to the strongest beam quality corresponding to the M time instances.

In the embodiments of the present disclosure, if the beam information reported by the terminal includes the beam quality corresponding to the reference signal indicator, the terminal may report the absolute value of the strongest beam quality among the beam qualities corresponding to the M time instances, and then for each time instance, report the relative values of the other beam qualities except the strongest beam quality among the beam qualities corresponding to the M time instances with respect to the strongest beam quality.

For example, the M time instances include time instance A, time instance B, and time instance C. Time instance A corresponds to beam quality 1, beam quality 2, and beam quality 3. Time instance B corresponds to beam quality 4, beam quality 5, and beam quality 6. Time instance C corresponds to beam quality 7, beam quality 8, and beam quality 9, among which beam quality 7 is the strongest among the beam qualities corresponding to the three time instances.

Then the terminal reports the absolute value of beam quality 7 corresponding to time instance C, the relative value of beam quality 1 with respect to beam quality 7, the relative value of beam quality 2 with respect to beam quality 7, the relative value of beam quality 3 with respect to beam quality 7, and reports the relative value of beam quality 4 corresponding to time instance B with respect to beam quality 7, the relative value of beam quality 5 with respect to beam quality 7, the relative value of beam quality 6 with respect to beam quality 4, and reports the relative value of beam quality 8 corresponding to time instance C with respect to beam quality 7, and the relative value of beam quality 9 with respect to beam quality 7.

It should be noted that the terminal may adopt different forms of reporting the beam information corresponding to the M time instances.

In some embodiments, the forms of reporting the beam information corresponding to the M time instances include at least one of the following:
(1) non-group-based beam reporting form;
(2) group-based beam reporting form.

Optionally, the group-based beam reporting form includes at least one of the following:
(1) reporting two reference signal indicators, where the two reference signal indicators belong to a same group, or belong to two groups, and the two reference signal indicators correspond to two reference signals that a terminal can receive simultaneously;
(2) reporting more than one group, among which each group including two reference signal indicators, and the two reference signal indicators within each group correspond to two reference signals that a terminal can receive simultaneously.

In the solutions provided in the embodiments of the present disclosure, the terminal may report the beam quality in different ways, expanding the ways of reporting the beam quality and also ensuring the accuracy of the terminal reporting the beam quality.

It should be noted that the above-mentioned embodiments may be split into new embodiments or combined with other embodiments to form new embodiments. The present disclosure does not limit the combination between the embodiments.

FIG. 7 is a flow diagram showing a beam report reporting method provided by an exemplary embodiment of the present disclosure. This method may be applied, for example, to the terminal as shown in FIG. 3. This method includes at least part of the following contents:
Step 701: the terminal sends a beam report to the network device, the beam report including beam information corresponding to M time instances, where M is a positive integer.

Herein the time instance may be referred to as “time instance”. In some embodiments, the time instance may also be understood as a time point or a time period, that is to say, the beam report includes beam information corresponding to M time points or time periods. The beam report refers to the information corresponding to the beam determined by the terminal, and then the terminal informs the network device of the corresponding beam information through the beam report.

The beam information corresponding to M time instances refers to the beam information of the beam corresponding to the M time instances determined by the terminal.

In the embodiments of the present disclosure, after the terminal determines the beam information corresponding to M time instances, it may carry the beam information in the beam report and send the beam report to the network device. Then, the network device may determine the beam information according to the beam report.

In some embodiments, the beam information corresponding to M time instances includes the beam information obtained by the terminal through beam measurement and/or beam information predicted based on a beam prediction model. The beam information predicted based on a beam prediction model is determined by the terminal based on beam information obtained through the beam measurement and the beam prediction model.

Optionally, the beam information included in the M time instances includes any of the following situations:
(1) The beam information corresponding to each of the M time instances includes the beam information obtained by the terminal through beam measurement.
(2) The beam information corresponding to each of the M time instances includes the beam information predicted by the terminal based on the beam prediction model.
(3) The beam information corresponding to at least one of the M time instances includes the beam information obtained by the terminal through beam measurement, and the beam information corresponding to at least another time instance of the M time instances includes the beam information predicted based on the beam prediction model.

It should be noted that if the terminal needs to perform beam measurement, it is needed that the network device configures reference signal measurement resources for the terminal in advance, and then the terminal conducts beam measurement based on the configured reference signal measurement resources to obtain beam information.

Optionally, the network device sends configuration information to the terminal. This configuration information is used to configure the reference signal measurement resources for beam measurement. The terminal receives this configuration information and may determine the reference signal measurement resources for beam measurement, and then perform beam measurement based on these reference signal measurement resources.

The present disclosure provides a solution for reporting beam information corresponding to a plurality of time instances, and the beam information corresponding to M time instances may be understood as the beam information determined by the terminal for the M time instances. The terminal may report the beam information of the M time instances to the network device through a beam report. That is to say, the terminal can simultaneously report the beam information of more than one time instance, breaking through the limitation of only being able to report the beam measurement result of one time instance, thereby ensuring the reliability of communication.

In some embodiments, if each of the M time instances corresponds to a time period, and the length of each time period is the same, that is to say, the M time instances cycle at the same period.

In some embodiments, if each of the M time instances corresponds to a time period, and the length of each time period is different, for example, there are two length values of the time periods, one corresponding to a long period and the other corresponding to a short period.

In some other embodiments, if the interval between each two adjacent time instances among the M time instances is a preset interval, where the preset interval contains only one preset interval value, that is to say, the time instances also cycle at the same period, and the interval between two adjacent time instances is the same preset interval.

In some other embodiments, if the interval between each two adjacent time instances among the M time instances is a preset interval, where the preset interval includes a plurality of preset interval values, such as preset interval 1 and preset interval 2, preset interval 1 corresponding to a long period and preset interval 2 corresponding to a short period.

For M time instances, the value of M is indicated by the network device, or it may also be indicated by the terminal. The following provides explanations for each indication situation.

The first type: The value of M is indicated by the network device. The terminal receives the first indication information sent by the network device, where this first indication information is used to indicate the value of M.

In the embodiments of the present disclosure, the network device may determine the value of M, and then indicate the value of M to the terminal through the first indication information. Then the terminal may report the beam information corresponding to M time instances to the network device according to the value of M.

In some embodiments, after the network device indicates the value of M, the time periods corresponding to the M time instances or the intervals between adjacent time instances among the M time instances may be determined in a plurality of ways. The following is an explanation of each determination way:

The first way: The time period corresponding to each of the M time instances is determined based on the historical time period, which is the time period during which the terminal conducts beam reporting.

In the embodiments of the present disclosure, there is a time period corresponding to each of the M time instances, and the terminal may perform beam reporting according to the historical time period. That is to say, the terminal may determine the historical time period, and then the terminal may determine the time period corresponding to each time instance based on the historical time period.

In some embodiments, the length of the period corresponding to each of the M time instances is the same as the length of the historical period. Optionally, in the embodiments of the present disclosure, it may also be understood that the cycle length of each time instance is the same as the cycle length corresponding to the historical period.

For example, as shown in FIG. 1, the length of the time period corresponding to each of the M time instances is the same as the length of each of the N historical time periods.

In some other embodiments, the length of the time period corresponding to each of the M time instances is less than the length of the historical period. That is to say, each historical period includes the period lengths corresponding to more than one time instances.

Optionally, the length of the time period corresponding to each time instance is the ratio of the length of the historical time period to M+1.

For example, as shown in FIG. 2, the length of the time period corresponding to each time instance is the ratio of the length of the historical time period to 4.

In some other embodiments, the length of the time period corresponding to each of the M time instances is greater than the length of the historical time period.

In some other embodiments, the length of the time period corresponding to X time instances among the M time instances is equal to the length of the historical time period, and the length of the time period corresponding to Y time instances among the M time instances is less than or greater than the length of the historical time period, where X+Y=M, and both X and Y are positive integers.

The second way: The preset interval between each two adjacent time instances is determined based on the historical interval, and the historical interval is the interval at which the terminal conducts beam reporting.

In the embodiment of the present disclosure, there is a preset interval corresponding to every two adjacent time instances among the M time instances, and the terminal may conduct beam measurement according to the historical interval. That is to say, the terminal may determine the historical interval, and then the terminal may determine the preset interval corresponding to each time instance based on the historical interval.

In some embodiments, the length of the preset interval corresponding to every two adjacent time instances among the M time instances is the same as the historical interval length.

For example, referring to FIG. 1, the length of the preset interval corresponding to every two adjacent time instances among the M time instances is the same as the length of each historical interval among the N historical intervals.

In other embodiments, the length of the preset interval corresponding to every two adjacent time instances among the M time instances is less than the historical interval length. That is to say, each historical interval length includes a plurality of preset interval lengths.

Optionally, each preset interval length is the ratio of the historical interval length to M+1.

For example, referring to FIG. 2, each historical interval length includes 4 preset interval lengths, that is to say, each preset interval length is the ratio of the historical interval length to 4.

In some other embodiments, the preset interval length corresponding to every two adjacent time instances among the M time instances is greater than the historical interval length.

In some other embodiments, the preset interval length corresponding to every two adjacent time instances among X time instances among the M time instances is equal to the historical interval length, and the preset interval length corresponding to each two adjacent time instances among Y time instances among the M time instances is less than or equal to the historical interval length, where X+Y=M, and both X and Y are positive integers.

The third way: The time period corresponding to each of the M time instances is determined based on the future time period, and the future time period is the time period during which the terminal conducts beam prediction.

In the embodiments of the present disclosure, the terminal may conduct beam prediction based on the beam information corresponding to the historical time period, thereby obtaining the predicted beam information, and the length of the time period corresponding to the predicted time instance may be determined based on the length of the future time period.

Optionally, the length of the future time period is set by the terminal, or by the network device, or agreed upon by the communication protocol.

In some embodiments, the length of the time period corresponding to each time instance is the same as the length of the future time period.

In other embodiments, the length of the future time period includes the lengths of the time periods corresponding to a plurality of time instances.

Optionally, the length of the time period corresponding to each time instance is the ratio of the length of the future time period to the number of time instances.

In some other embodiments, the length of the time period corresponding to each time instance is greater than the length of the future time period.

The fourth way: The preset interval between every two adjacent time instances is determined based on the future interval, and the future interval is the interval at which the terminal performs beam prediction.

In the embodiment of the present disclosure, the terminal may perform beam prediction based on the beam information corresponding to the historical time period, and then obtain the predicted beam information. Moreover, the preset interval corresponding to the predicted time instance may be determined based on the future interval length.

Optionally, the future interval length is set by the terminal, or by the network device, or agreed upon by the communication protocol.

In some embodiments, the preset interval length corresponding to each time instance is the same as the future interval length.

In other embodiments, the future interval length includes the preset interval lengths corresponding to a plurality of time instances.

In other embodiments, the preset interval length corresponding to each time instance is greater than the future interval length.

In the solutions provided in the embodiments of the present disclosure, the network device may indicate the value of M, and then the time period corresponding to the M time instances or the interval between adjacent time instances is determined by various ways, so that the terminal reports the beam report based on the determined time period corresponding to the M time instances or the interval between adjacent time instances, which improves the accuracy of reporting the beam report.

In some embodiments, the terminal needs to report its own capabilities to the network device, and then the network device may determine the value of M indicated by the first indication information based on the maximum number of time instances supported by the terminal.

Herein the terminal sends terminal capability information to the network device, and this terminal capability information indicates the maximum number L of time instances included in the beam report supported by the terminal, and M is not greater than L.

In the embodiment of the present disclosure, the terminal indicates the maximum number L of time instances included in the beam report supported by the terminal through the sent terminal capability information. After the network device receives the L, the network device will determine an M that is not greater than L, and then send indication information for indicating the M to the terminal.

In the solutions provided in the embodiments of the present disclosure, the terminal reports to the network device the maximum number of time instances included in the beam report supported by itself, so that the network device may determine M according to the capability of the terminal, that is, the determined value of M is not greater than L, ensuring the accuracy of the value of M indicated by the network device, and further ensuring the reliability of the beam report reported by the terminal.

The second type: The value of M is indicated by the terminal. In some embodiments, the terminal sends the second indication information to the network device, where this second indication information is used to indicate the value of M.

In the embodiments of the present disclosure, the terminal may also determine the value of M by itself, and then the terminal may indicate the determined value of M to the network device through the second indication information.

In some embodiments, this second indication information is determined by the terminal based on the obtained beam information of different time instances.

In the embodiments of the present disclosure, the terminal may obtain the beam information of different time instances and determine the value of M according to the obtained beam information. Further, this second indication information also includes the identification of the time instance to indicate which time instances corresponding to the beam information reported by the terminal.

Optionally, the terminal determines the value of M to be reported based on whether the obtained beam information of different time instances is similar.

Optionally, under the circumstance of the K beams corresponding to the strongest beam quality included in the beam information of different time instances obtained by the terminal are the same, it is determined that the beam information of different time instances is similar. Conversely, it is determined that the beam information of different time instances is not similar.

For example, the terminal may predict the beam information of 4 time instances. If it is determined that the beam information of two adjacent times is approximately the same, only the beam information of 2 time instances may be reported, and it is indicated which two time instances these two time instances correspond to.

In some embodiments, the network device also indicates to the terminal the maximum number of time instances reported by the terminal. Herein the number of time instances reported by the terminal is not greater than the maximum number.

Optionally, the terminal determines the value of M to be reported based on whether the obtained beam information of different time instances is similar.

Optionally, under the circumstance of the K beams corresponding to the strongest beam quality at least included in the beam information of different time instances obtained by the terminal are the same, it is determined that the beam information of different time instances is similar. Conversely, it is determined that the beam information of different time instances is not similar.

For example, the terminal determines that the X time instances correspond to time instance #1, time instance #2, time instance #3, and time instance #4. The terminal finds that the beam information of time instance #1 and time instance #2 is approximately the same, and the beam information of time instance #3 and time instance #4 is approximately the same. Then, only the beam information of time instance #1 and time instance #3 may be reported. Time instance #2 continues to use the beam information of time instance #1, and time instance #4 continues to use the beam information of time instance #3.

In some embodiments, after the terminal determines the value of M, the time periods corresponding to the M time instances or the intervals between adjacent time instances among the M time instances may be determined in a plurality of ways. The following is an explanation of each determination way:

The first way: The time period corresponding to each of the M time instances is determined based on the historical time period, which is the time period during which the terminal conducts beam measurement.

In the embodiment of the present disclosure, there is a time period corresponding to each of the M time instances, and the terminal may perform beam measurement according to the historical time period. That is to say, the terminal may determine the historical time period, and then the terminal may determine the time period corresponding to each time instance based on the historical time period.

In some embodiments, the length of the period corresponding to each of the M time instances is the same as the length of the historical period. Optionally, in the embodiments of the present disclosure, it may also be understood that the cycle length of each time instance is the same as the cycle length corresponding to the historical period.

For example, as shown in FIG. 1, the length of the time period corresponding to each of the M time instances is the same as the length of each of the N historical time periods.

In some other embodiments, the length of the time period corresponding to each of the M time instances is less than the length of the historical period. That is to say, each historical period includes the period lengths corresponding to more than one time instances.

Optionally, the length of the time period corresponding to each time instance is the ratio of the length of the historical time period to M+1.

For example, as shown in FIG. 2, the length of the time period corresponding to each time instance is the ratio of the length of the historical time period to 4.

In some other embodiments, the length of the time period corresponding to each of the M time instances is greater than the length of the historical time period.

In some other embodiments, the length of the time period corresponding to X time instances among the M time instances is equal to the length of the historical time period, and the length of the time period corresponding to Y time instances among the M time instances is less than or greater than the length of the historical time period, where X+Y=M, and both X and Y are positive integers.

The second way: The preset interval between each two adjacent time instances is determined based on the historical interval, and the historical interval is the interval at which the terminal conducts beam reporting.

In the embodiment of the present disclosure, there is a preset interval corresponding to every two adjacent time instances among the M time instances, and the terminal may conduct beam measurement according to the historical interval. That is to say, the terminal may determine the historical interval, and then the terminal may determine the preset interval corresponding to each time instance based on the historical interval.

In some embodiments, the length of the preset interval corresponding to every two adjacent time instances among the M time instances is the same as the historical interval length.

For example, referring to FIG. 1, the length of the preset interval corresponding to every two adjacent time instances among the M time instances is the same as the length of each historical interval among the N historical intervals.

In other embodiments, the length of the preset interval corresponding to every two adjacent time instances among the M time instances is less than the historical interval length. That is to say, each historical interval length includes a plurality of preset interval lengths.

Optionally, each preset interval length is the ratio of the historical interval length to M+1.

For example, referring to FIG. 2, each historical interval length includes 4 preset interval lengths, that is to say, each preset interval length is the ratio of the historical interval length to 4.

In some other embodiments, the preset interval length corresponding to every two adjacent time instances among the M time instances is greater than the historical interval length.

In some other embodiments, the preset interval length corresponding to every two adjacent time instances among X time instances among the M time instances is equal to the historical interval length, and the preset interval length corresponding to each two adjacent time instances among Y time instances among the M time instances is less than or equal to the historical interval length, where X+Y=M, and both X and Y are positive integers.

The third way: The time period corresponding to each of the M time instances is determined based on the future time period, and the future time period is the time period during which the terminal conducts beam prediction.

In the embodiments of the present disclosure, the terminal may conduct beam prediction based on the beam information corresponding to the historical time period, thereby obtaining the predicted beam information, and the length of the time period corresponding to the predicted time instance may be determined based on the length of the future time period.

Optionally, the length of the future time period is set by the terminal, or by the network device, or agreed upon by the communication protocol.

In some embodiments, the length of the time period corresponding to each time instance is the same as the length of the future time period.

In some other embodiments, the length of the future time period includes the lengths of the time periods corresponding to a plurality of time instances.

Optionally, the length of the time period corresponding to each time instance is the ratio of the length of the future time period to the number of time instances.

In some other embodiments, the length of the time period corresponding to each time instance is greater than the length of the future time period.

The fourth way: The preset interval between every two adjacent time instances is determined based on the future interval, and the future interval is the interval at which the terminal performs beam prediction.

In the embodiment of the present disclosure, the terminal may perform beam prediction based on the beam information corresponding to the historical time period, and then obtain the predicted beam information. Moreover, the preset interval length corresponding to the predicted time instance may be determined based on the future interval length.

Optionally, the future interval length is set by the terminal, or by the network device, or agreed upon by the communication protocol.

In some embodiments, the preset interval length corresponding to each time instance is the same as the future interval length.

In other embodiments, the future interval length includes the preset interval lengths corresponding to a plurality of time instances.

In other embodiments, the preset interval length corresponding to each time instance is greater than the future interval length.

In the solutions provided in the embodiments of the present disclosure, the network device may indicate the value of M, and then the time period corresponding to the M time instances or the interval between adjacent time instances is determined by various ways, so that the terminal reports the beam report based on the determined time period corresponding to the M time instances or the interval between adjacent time instances, which improves the accuracy of reporting the beam report.

On the basis that it is illustrated in the above-mentioned embodiments that the terminal reports the beam information corresponding to a plurality of time instances, the beam information is described.

In some embodiments, the beam information includes at least one of the following:
(1) reference signal indicator.

Herein the reference signal indicator is used to indicate the reference signal. In some embodiments, the reference signal indicator is represented by RS ID (Reference Signal indicator).

Optionally, the reference signal indicator includes a Synchronization PBCH block (SSB) resource indicator or a Channel State Information Reference Signal (CSI-RS).

(2) The beam quality corresponding to the reference signal indicator.

Herein the beam quality refers to the beam quality determined by the terminal based on the reference signal indicated through the reference signal indicator. In some embodiments, the beam quality includes at least one of Layer 1 (L1)-Reference Signal Received Power (RSRP) or L1-Signal to Interference plus Noise Ratio Received Power (SINR).

In some embodiments, if the beam information includes the beam quality corresponding to the reference signal indicator, the terminal may report the beam quality in different ways.

The first way of reporting: under the circumstance of the beam information including the beam quality corresponding to the reference signal indicator, the beam information includes absolute values of the M strongest beam qualities, where the M strongest beam qualities correspond one-to-one to the M time instances, the beam information further includes relative values of the other beam qualities except the strongest beam quality corresponding to the i-th time instance among the M time instances with respect to the strongest beam quality corresponding to the i-th time instance, where i takes integer values from 1 to M.

In the embodiments of the present disclosure, if the beam information reported by the terminal includes the beam quality corresponding to the reference signal indicator, the terminal may report the strongest beam qualities corresponding to the M time instances respectively, and then for each time instance, report the relative values of the other beam qualities except the strongest beam quality corresponding to the time instance with respect to the strongest beam quality.

For example, the M time instances include time instance A, time instance B, and time instance C. Time instance A corresponds to beam quality 1, beam quality 2, and beam quality 3, among which beam quality 1 is the strongest. Time instance B corresponds to beam quality 4, beam quality 5, and beam quality 6, among which beam quality 4 is the strongest. Time instance C corresponds to beam quality 7, beam quality 8, and beam quality 9, among which beam quality 7 is the strongest.

Then the terminal reports the absolute value of beam quality 1 corresponding to time instance A, the relative value of beam quality 2 with respect to beam quality 1, and the relative value of beam quality 3 with respect to beam quality 1, and reports the absolute value of beam quality 4 corresponding to time instance B, the relative value of beam quality 5 with respect to beam quality 4, and the relative value of beam quality 6 with respect to beam quality 4, and reports the absolute value of beam quality 7 corresponding to time instance C, the relative value of beam quality 8 with respect to beam quality 7, and the relative value of beam quality 9 with respect to beam quality 7.

The second way of reporting: under the circumstance of the beam information including beam quality corresponding to the reference signal indicator, the beam information includes an absolute value of one strongest beam quality, where the one strongest beam quality corresponds to the target time instance among the M time instances, the beam information further includes relative values of the other beam qualities except the strongest beam quality with respect to the strongest beam quality corresponding to the M time instances.

In the embodiments of the present disclosure, if the beam information reported by the terminal includes the beam quality corresponding to the reference signal indicator, the terminal may report the absolute value of the strongest beam quality among the beam qualities corresponding to the M time instances, and then for each time instance, report the relative values of the other beam qualities except the strongest beam quality among the beam qualities corresponding to the M time instances with respect to the strongest beam quality.

For example, the M time instances include time instance A, time instance B, and time instance C. Time instance A corresponds to beam quality 1, beam quality 2, and beam quality 3. Time instance B corresponds to beam quality 4, beam quality 5, and beam quality 6. Time instance C corresponds to beam quality 7, beam quality 8, and beam quality 9, among which beam quality 7 is the strongest among the beam qualities corresponding to the three time instances.

Then the terminal reports the absolute value of beam quality 7 corresponding to time instance C, the relative value of beam quality 1 with respect to beam quality 7, the relative value of beam quality 2 with respect to beam quality 7, the relative value of beam quality 3 with respect to beam quality 7, and reports the relative value of beam quality 4 corresponding to time instance B with respect to beam quality 7, the relative value of beam quality 5 with respect to beam quality 7, the relative value of beam quality 6 with respect to beam quality 4, and reports the relative value of beam quality 8 corresponding to time instance C with respect to beam quality 7, and the relative value of beam quality 9 with respect to beam quality 7.

It should be noted that the terminal may adopt different forms of reporting the beam information corresponding to the M time instances.

In some embodiments, the forms of reporting the beam information corresponding to the M time instances include at least one of the following:
(1) non-group-based beam reporting form;
(2) group-based beam reporting form.

Optionally, the group-based beam reporting form includes at least one of the following:
(1) reporting two reference signal indicators, where the two reference signal indicators belong to a same group, or belong to two groups, and the two reference signal indicators correspond to two reference signals that a terminal can receive simultaneously;
(2) reporting more than one group, among which each group including two reference signal indicators, and the two reference signal indicators within each group correspond to two reference signals that a terminal can receive simultaneously.

In the solutions provided in the embodiments of the present disclosure, the terminal may report the beam quality in different ways, expanding the ways of reporting the beam quality and also ensuring the accuracy of the terminal reporting the beam quality.

FIG. 8 is a flow diagram showing a beam report receiving method provided by an exemplary embodiment of the present disclosure. This method may be applied, for example, to the network devices as shown in FIG. 3. This method includes at least part of the following contents:
Step 801: the network device receives a beam report sent by a terminal, the beam report including beam information corresponding to M time instances, where M is a positive integer.

Herein the time instance may be referred to as “time instance”. In some embodiments, the time instance may also be understood as a time point or a time period, that is to say, the beam report includes beam information corresponding to M time points or time periods. The beam report refers to the information corresponding to the beam determined by the terminal, and then the terminal informs the network device of the corresponding beam information through the beam report.

The beam information corresponding to M time instances refers to the beam information of the beam corresponding to the M time instances determined by the terminal.

In the embodiments of the present disclosure, after the terminal determines the beam information corresponding to M time instances, it may carry the beam information in the beam report and send the beam report to the network device. Then, the network device may determine the beam information according to the beam report.

In some embodiments, the beam information corresponding to M time instances includes the beam information obtained by the terminal through beam measurement and/or beam information predicted based on a beam prediction model. The beam information predicted based on a beam prediction model is determined by the terminal based on beam information obtained through the beam measurement and the beam prediction model.

Optionally, the beam information included in the M time instances includes any of the following situations:
(1) The beam information corresponding to each of the M time instances includes the beam information obtained by the terminal through beam measurement.
(2) The beam information corresponding to each of the M time instances includes the beam information predicted by the terminal based on the beam prediction model.
(3) The beam information corresponding to at least one of the M time instances includes the beam information obtained by the terminal through beam measurement, and the beam information corresponding to at least another time instance of the M time instances includes the beam information predicted based on the beam prediction model.

It should be noted that if the terminal needs to perform beam measurement, it is needed that the network device configures reference signal measurement resources for the terminal in advance, and then the terminal conducts beam measurement based on the configured reference signal measurement resources to obtain beam information.

Optionally, the network device sends configuration information to the terminal. This configuration information is used to configure the reference signal measurement resources for beam measurement. The terminal receives this configuration information and may determine the reference signal measurement resources for beam measurement, and then perform beam measurement based on these reference signal measurement resources.

The present disclosure provides a solution for reporting beam information corresponding to a plurality of time instances, and the beam information corresponding to M time instances may be understood as the beam information determined by the terminal for the M time instances. The terminal may report the beam information of the M time instances to the network device through a beam report. That is to say, the terminal can simultaneously report the beam information of more than one time instance, breaking through the limitation of only being able to report the beam measurement result of one time instance, thereby ensuring the reliability of communication.

In the embodiments of the present disclosure, each of the M time instances corresponds to a time period, or, an interval between every two adjacent time instances among the M time instances is a preset interval.

In some embodiments, if each of the M time instances corresponds to a time period, and the length of each time period is the same, that is to say, the M time instances cycle at the same period.

In some embodiments, if each of the M time instances corresponds to a time period, and the length of each time period is different, for example, there are two length values of the time periods, one corresponding to a long period and the other corresponding to a short period.

In some other embodiments, if the interval between each two adjacent time instances among the M time instances is a preset interval, where the preset interval contains only one preset interval value, that is to say, the time instances also cycle at the same period, and the interval between two adjacent time instances is the same preset interval.

In some other embodiments, if the interval between each two adjacent time instances among the M time instances is a preset interval, where the preset interval includes a plurality of preset interval values, such as preset interval 1 and preset interval 2, preset interval 1 corresponding to a long period and preset interval 2 corresponding to a short period.

For M time instances, the value of M is indicated by the network device, or it may also be indicated by the terminal. The following provides explanations for each indication situation.

The first type: The value of M is indicated by the network device. In some embodiments, the network device sends the first indication information to the terminal, where this first indication information is used to indicate the value of M.

In the embodiments of the present disclosure, the network device may determine the value of M, and then indicate the value of M to the terminal through the first indication information. Then the terminal may report the beam information corresponding to M time instances to the network device according to the value of M.

In some embodiments, after the network device indicates the value of M, the time periods corresponding to the M time instances or the intervals between adjacent time instances among the M time instances may be determined in a plurality of ways. The following is an explanation of each determination way:

The first way: The time period corresponding to each of the M time instances is determined based on the historical time period, which is the time period during which the terminal conducts beam reporting.

In the embodiments of the present disclosure, there is a time period corresponding to each of the M time instances, and the terminal may perform beam reporting according to the historical time period. That is to say, the terminal may determine the historical time period, and then the terminal may determine the time period corresponding to each time instance based on the historical time period.

In some embodiments, the length of the period corresponding to each of the M time instances is the same as the length of the historical period. Optionally, in the embodiments of the present disclosure, it may also be understood that the cycle length of each time instance is the same as the cycle length corresponding to the historical period.

For example, as shown in FIG. 1, the length of the time period corresponding to each of the M time instances is the same as the length of each of the N historical time periods.

In some other embodiments, the length of the time period corresponding to each of the M time instances is less than the length of the historical period. That is to say, each historical period includes the period lengths corresponding to more than one time instances.

Optionally, the length of the time period corresponding to each time instance is the ratio of the length of the historical time period to M+1.

For example, as shown in FIG. 2, the length of the time period corresponding to each time instance is the ratio of the length of the historical time period to 4.

In some other embodiments, the length of the time period corresponding to each of the M time instances is greater than the length of the historical time period.

In some other embodiments, the length of the time period corresponding to X time instances among the M time instances is equal to the length of the historical time period, and the length of the time period corresponding to Y time instances among the M time instances is less than or greater than the length of the historical time period, where X+Y=M, and both X and Y are positive integers.

The second way: The preset interval between each two adjacent time instances is determined based on the historical interval, and the historical interval is the interval at which the terminal conducts beam reporting.

In the embodiment of the present disclosure, there is a preset interval corresponding to every two adjacent time instances among the M time instances, and the terminal may conduct beam measurement according to the historical interval. That is to say, the terminal may determine the historical interval, and then the terminal may determine the preset interval corresponding to each time instance based on the historical interval.

In some embodiments, the length of the preset interval corresponding to every two adjacent time instances among the M time instances is the same as the historical interval length.

For example, referring to FIG. 1, the length of the preset interval corresponding to every two adjacent time instances among the M time instances is the same as the length of each historical interval among the N historical intervals.

In other embodiments, the length of the preset interval corresponding to every two adjacent time instances among the M time instances is less than the historical interval length. That is to say, each historical interval length includes a plurality of preset interval lengths.

Optionally, each preset interval length is the ratio of the historical interval length to M+1.

For example, referring to FIG. 2, each historical interval length includes 4 preset interval lengths, that is to say, each preset interval length is the ratio of the historical interval length to 4.

In some other embodiments, the preset interval length corresponding to every two adjacent time instances among the M time instances is greater than the historical interval length.

In some other embodiments, the preset interval length corresponding to every two adjacent time instances among X time instances among the M time instances is equal to the historical interval length, and the preset interval length corresponding to each two adjacent time instances among Y time instances among the M time instances is less than or equal to the historical interval length, where X+Y=M, and both X and Y are positive integers.

The third way: The time period corresponding to each of the M time instances is determined based on the future time period, and the future time period is the time period during which the terminal conducts beam prediction.

In the embodiments of the present disclosure, the terminal may conduct beam prediction based on the beam information corresponding to the historical time period, thereby obtaining the predicted beam information, and the length of the time period corresponding to the predicted time instance may be determined based on the length of the future time period.

Optionally, the length of the future time period is set by the terminal, or by the network device, or agreed upon by the communication protocol.

In some embodiments, the length of the time period corresponding to each time instance is the same as the length of the future time period.

In other embodiments, the length of the future time period includes the lengths of the time periods corresponding to a plurality of time instances.

Optionally, the length of the time period corresponding to each time instance is the ratio of the length of the future time period to the number of time instances.

In some other embodiments, the length of the time period corresponding to each time instance is greater than the length of the future time period.

The fourth way: The preset interval between every two adjacent time instances is determined based on the future interval, and the future interval is the interval at which the terminal performs beam prediction.

In the embodiment of the present disclosure, the terminal may perform beam prediction based on the beam information corresponding to the historical time period, and then obtain the predicted beam information. Moreover, the preset interval corresponding to the predicted time instance may be determined based on the future interval length.

Optionally, the future interval length is set by the terminal, or by the network device, or agreed upon by the communication protocol.

In some embodiments, the preset interval length corresponding to each time instance is the same as the future interval length.

In other embodiments, the future interval length includes the preset interval lengths corresponding to a plurality of time instances.

In other embodiments, the preset interval length corresponding to each time instance is greater than the future interval length.

In the solutions provided in the embodiments of the present disclosure, the network device may indicate the value of M, and then the time period corresponding to the M time instances or the interval between adjacent time instances is determined by various ways, so that the terminal reports the beam report based on the determined time period corresponding to the M time instances or the interval between adjacent time instances, which improves the accuracy of reporting the beam report.

In some embodiments, the terminal needs to report its own capabilities to the network device, and then the network device may determine the value of M indicated by the first indication information based on the maximum number of time instances supported by the terminal.

Herein the terminal sends terminal capability information to the network device, and this terminal capability information indicates the maximum number L of time instances included in the beam report supported by the terminal, and M is not greater than L.

In the embodiment of the present disclosure, the terminal indicates the maximum number L of time instances included in the beam report supported by the terminal through the sent terminal capability information. After the network device receives the L, the network device will determine an M that is not greater than L, and then send indication information for indicating the M to the terminal.

In the solutions provided in the embodiments of the present disclosure, the terminal reports to the network device the maximum number of time instances included in the beam report supported by itself, so that the network device may determine M according to the capability of the terminal, that is, the determined value of M is not greater than L, ensuring the accuracy of the value of M indicated by the network device, and further ensuring the reliability of the beam report reported by the terminal.

The second type: The value of M is indicated by the terminal. In some embodiments, the terminal sends the second indication information to the network device, where this second indication information is used to indicate the value of M.

In the embodiments of the present disclosure, the terminal may also determine the value of M by itself, and then the terminal may indicate the determined value of M to the network device through the second indication information.

In some embodiments, this second indication information is determined by the terminal based on the obtained beam information of different time instances.

In the embodiments of the present disclosure, the terminal may obtain the beam information of different time instances and determine the value of M according to the obtained beam information. Further, this second indication information also includes the identification of the time instance to indicate which time instances corresponding to the beam information reported by the terminal.

Optionally, the terminal determines the value of M to be reported based on whether the obtained beam information of different time instances is similar.

Optionally, under the circumstance of the K beams corresponding to the strongest beam quality included in the beam information of different time instances obtained by the terminal are the same, it is determined that the beam information of different time instances is similar. Conversely, it is determined that the beam information of different time instances is not similar.

For example, the terminal may predict the beam information of 4 time instances. If it is determined that the beam information of two adjacent times is approximately the same, only the beam information of 2 time instances may be reported, and it is indicated which two time instances these two time instances correspond to.

In some embodiments, the network device also indicates to the terminal the maximum number of time instances reported by the terminal. Herein the number of time instances reported by the terminal is not greater than the maximum number.

Optionally, the terminal determines the value of M to be reported based on whether the obtained beam information of different time instances is similar.

Optionally, under the circumstance of the K beams corresponding to the strongest beam quality at least included in the beam information of different time instances obtained by the terminal are the same, it is determined that the beam information of different time instances is similar. Conversely, it is determined that the beam information of different time instances is not similar.

For example, the terminal determines that the X time instances correspond to time instance #1, time instance #2, time instance #3, and time instance #4. The terminal finds that the beam information of time instance #1 and time instance #2 is approximately the same, and the beam information of time instance #3 and time instance #4 is approximately the same. Then, only the beam information of time instance #1 and time instance #3 may be reported. Time instance #2 continues to use the beam information of time instance #1, and time instance #4 continues to use the beam information of time instance #3.

In some embodiments, after the terminal determines the value of M, the time periods corresponding to the M time instances or the intervals between adjacent time instances among the M time instances may be determined in a plurality of ways. The following is an explanation of each determination way:

The first way: The time period corresponding to each of the M time instances is determined based on the historical time period, which is the time period during which the terminal conducts beam measurement.

In the embodiment of the present disclosure, there is a time period corresponding to each of the M time instances, and the terminal may perform beam measurement according to the historical time period. That is to say, the terminal may determine the historical time period, and then the terminal may determine the time period corresponding to each time instance based on the historical time period.

In some embodiments, the length of the period corresponding to each of the M time instances is the same as the length of the historical period. Optionally, in the embodiments of the present disclosure, it may also be understood that the cycle length of each time instance is the same as the cycle length corresponding to the historical period.

For example, as shown in FIG. 1, the length of the time period corresponding to each of the M time instances is the same as the length of each of the N historical time periods.

In some other embodiments, the length of the time period corresponding to each of the M time instances is less than the length of the historical period. That is to say, each historical period includes the period lengths corresponding to more than one time instances.

Optionally, the length of the time period corresponding to each time instance is the ratio of the length of the historical time period to M+1.

For example, as shown in FIG. 2, the length of the time period corresponding to each time instance is the ratio of the length of the historical time period to 4.

In some other embodiments, the length of the time period corresponding to each of the M time instances is greater than the length of the historical time period.

In some other embodiments, the length of the time period corresponding to X time instances among the M time instances is equal to the length of the historical time period, and the length of the time period corresponding to Y time instances among the M time instances is less than or greater than the length of the historical time period, where X+Y=M, and both X and Y are positive integers.

The second way: The preset interval between each two adjacent time instances is determined based on the historical interval, and the historical interval is the interval at which the terminal conducts beam reporting.

In the embodiment of the present disclosure, there is a preset interval corresponding to every two adjacent time instances among the M time instances, and the terminal may conduct beam measurement according to the historical interval. That is to say, the terminal may determine the historical interval, and then the terminal may determine the preset interval corresponding to each time instance based on the historical interval.

In some embodiments, the length of the preset interval corresponding to every two adjacent time instances among the M time instances is the same as the historical interval length.

For example, referring to FIG. 1, the length of the preset interval corresponding to every two adjacent time instances among the M time instances is the same as the length of each historical interval among the N historical intervals.

In other embodiments, the length of the preset interval corresponding to every two adjacent time instances among the M time instances is less than the historical interval length. That is to say, each historical interval length includes a plurality of preset interval lengths.

Optionally, each preset interval length is the ratio of the historical interval length to M+1.

For example, referring to FIG. 2, each historical interval length includes 4 preset interval lengths, that is to say, each preset interval length is the ratio of the historical interval length to 4.

In some other embodiments, the preset interval length corresponding to every two adjacent time instances among the M time instances is greater than the historical interval length.

In some other embodiments, the preset interval length corresponding to every two adjacent time instances among X time instances among the M time instances is equal to the historical interval length, and the preset interval length corresponding to each two adjacent time instances among Y time instances among the M time instances is less than or equal to the historical interval length, where X+Y=M, and both X and Y are positive integers.

The third way: The time period corresponding to each of the M time instances is determined based on the future time period, and the future time period is the time period during which the terminal conducts beam prediction.

In the embodiments of the present disclosure, the terminal may conduct beam prediction based on the beam information corresponding to the historical time period, thereby obtaining the predicted beam information, and the length of the time period corresponding to the predicted time instance may be determined based on the length of the future time period.

Optionally, the length of the future time period is set by the terminal, or by the network device, or agreed upon by the communication protocol.

In some embodiments, the length of the time period corresponding to each time instance is the same as the length of the future time period.

In some other embodiments, the length of the future time period includes the lengths of the time periods corresponding to a plurality of time instances.

Optionally, the length of the time period corresponding to each time instance is the ratio of the length of the future time period to the number of time instances.

In some other embodiments, the length of the time period corresponding to each time instance is greater than the length of the future time period.

The fourth way: The preset interval between every two adjacent time instances is determined based on the future interval, and the future interval is the interval at which the terminal performs beam prediction.

In the embodiment of the present disclosure, the terminal may perform beam prediction based on the beam information corresponding to the historical time period, and then obtain the predicted beam information. Moreover, the preset interval length corresponding to the predicted time instance may be determined based on the future interval length.

Optionally, the future interval length is set by the terminal, or by the network device, or agreed upon by the communication protocol.

In some embodiments, the preset interval length corresponding to each time instance is the same as the future interval length.

In other embodiments, the future interval length includes the preset interval lengths corresponding to a plurality of time instances.

In other embodiments, the preset interval length corresponding to each time instance is greater than the future interval length.

In the solutions provided in the embodiments of the present disclosure, the network device may indicate the value of M, and then the time period corresponding to the M time instances or the interval between adjacent time instances is determined by various ways, so that the terminal reports the beam report based on the determined time period corresponding to the M time instances or the interval between adjacent time instances, which improves the accuracy of reporting the beam report.

On the basis that it is illustrated in the above-mentioned embodiments that the terminal reports the beam information corresponding to a plurality of time instances, the beam information is described.

In some embodiments, the beam information includes at least one of the following:
(1) reference signal indicator.

Herein the reference signal indicator is used to indicate the reference signal. In some embodiments, the reference signal indicator is represented by RS ID (Reference Signal indicator).

Optionally, the reference signal indicator includes a Synchronization PBCH block (SSB) resource indicator or a Channel State Information Reference Signal (CSI-RS).

(2) The beam quality corresponding to the reference signal indicator.

Herein the beam quality refers to the beam quality determined by the terminal based on the reference signal indicated through the reference signal indicator. In some embodiments, the beam quality includes at least one of Layer 1 (L1)-Reference Signal Received Power (RSRP) or L1-Signal to Interference plus Noise Ratio Received Power (SINR).

In some embodiments, if the beam information includes the beam quality corresponding to the reference signal indicator, the terminal may report the beam quality in different ways.

The first way of reporting: under the circumstance of the beam information including the beam quality corresponding to the reference signal indicator, the beam information includes absolute values of the M strongest beam qualities, where the M strongest beam qualities correspond one-to-one to the M time instances, the beam information further includes relative values of the other beam qualities except the strongest beam quality corresponding to the i-th time instance among the M time instances with respect to the strongest beam quality corresponding to the i-th time instance, where i takes integer values from 1 to M.

In the embodiments of the present disclosure, if the beam information reported by the terminal includes the beam quality corresponding to the reference signal indicator, the terminal may report the strongest beam qualities corresponding to the M time instances respectively, and then for each time instance, report the relative values of the other beam qualities except the strongest beam quality corresponding to the time instance with respect to the strongest beam quality.

For example, the M time instances include time instance A, time instance B, and time instance C. Time instance A corresponds to beam quality 1, beam quality 2, and beam quality 3, among which beam quality 1 is the strongest. Time instance B corresponds to beam quality 4, beam quality 5, and beam quality 6, among which beam quality 4 is the strongest. Time instance C corresponds to beam quality 7, beam quality 8, and beam quality 9, among which beam quality 7 is the strongest.

Then the terminal reports the absolute value of beam quality 1 corresponding to time instance A, the relative value of beam quality 2 with respect to beam quality 1, and the relative value of beam quality 3 with respect to beam quality 1, and reports the absolute value of beam quality 4 corresponding to time instance B, the relative value of beam quality 5 with respect to beam quality 4, and the relative value of beam quality 6 with respect to beam quality 4, and reports the absolute value of beam quality 7 corresponding to time instance C, the relative value of beam quality 8 with respect to beam quality 7, and the relative value of beam quality 9 with respect to beam quality 7.

The second way of reporting: under the circumstance of the beam information including beam quality corresponding to the reference signal indicator, the beam information includes an absolute value of one strongest beam quality, where the one strongest beam quality corresponds to the target time instance among the M time instances, the beam information further includes relative values of the other beam qualities except the strongest beam quality with respect to the strongest beam quality corresponding to the M time instances.

In the embodiments of the present disclosure, if the beam information reported by the terminal includes the beam quality corresponding to the reference signal indicator, the terminal may report the absolute value of the strongest beam quality among the beam qualities corresponding to the M time instances, and then for each time instance, report the relative values of the other beam qualities except the strongest beam quality among the beam qualities corresponding to the M time instances with respect to the strongest beam quality.

For example, the M time instances include time instance A, time instance B, and time instance C. Time instance A corresponds to beam quality 1, beam quality 2, and beam quality 3. Time instance B corresponds to beam quality 4, beam quality 5, and beam quality 6. Time instance C corresponds to beam quality 7, beam quality 8, and beam quality 9, among which beam quality 7 is the strongest among the beam qualities corresponding to the three time instances.

Then the terminal reports the absolute value of beam quality 7 corresponding to time instance C, the relative value of beam quality 1 with respect to beam quality 7, the relative value of beam quality 2 with respect to beam quality 7, the relative value of beam quality 3 with respect to beam quality 7, and reports the relative value of beam quality 4 corresponding to time instance B with respect to beam quality 7, the relative value of beam quality 5 with respect to beam quality 7, the relative value of beam quality 6 with respect to beam quality 4, and reports the relative value of beam quality 8 corresponding to time instance C with respect to beam quality 7, and the relative value of beam quality 9 with respect to beam quality 7.

It should be noted that the terminal may adopt different forms of reporting the beam information corresponding to the M time instances.

In some embodiments, the forms of reporting the beam information corresponding to the M time instances include at least one of the following:
(1) non-group-based beam reporting form;
(2) group-based beam reporting form.

Optionally, the group-based beam reporting form includes at least one of the following:
(1) reporting two reference signal indicators, where the two reference signal indicators belong to a same group, or belong to two groups, and the two reference signal indicators correspond to two reference signals that a terminal can receive simultaneously;
(2) reporting more than one group, among which each group including two reference signal indicators, and the two reference signal indicators within each group correspond to two reference signals that a terminal can receive simultaneously.

In the solutions provided in the embodiments of the present disclosure, the terminal may report the beam quality in different ways, expanding the ways of reporting the beam quality and also ensuring the accuracy of the terminal reporting the beam quality.

FIG. 9 is a block diagram showing a beam report reporting apparatus provided by an exemplary embodiment of the present disclosure. Referring to FIG. 9, the apparatus includes:

sending module 901, used to send a beam report to a network device, the beam report including beam information corresponding to M time instances, where M is a positive integer.

In some embodiments, the beam information corresponding to M time instances includes the beam information obtained by the terminal through beam measurement and/or beam information predicted based on a beam prediction model. The beam information predicted based on a beam prediction model is determined by the terminal based on beam information obtained through the beam measurement and the beam prediction model.

In some embodiments, each time instance among the M time instances corresponds to a time period, or the interval between every two adjacent time instances among the M time instances is a preset interval.

In some embodiments, referring to FIG. 10, the apparatus further includes:
receiving module 902, used to receive the first indication information sent by the network device, the first indication information used to indicate a value of M.

In some embodiments, the sending module 901 is further used to send terminal capability information to the network device, the terminal capability information indicating the maximum number L of time instances included in the beam report supported by the terminal, and M being not greater than L.

In some embodiments, the sending module 901 is further used to send the second indication information to the network device, the second indication information used to indicate the value of M.

In some embodiments, the second indication information is determined by the terminal based on obtained the beam information of different time instances.

In some embodiments, the time period corresponding to each of the M time instances is determined based on a historical time period, the historical time period being a time period during which the terminal conducts beam measurement;
or,
the preset interval between the every two adjacent time instances is determined based on a historical interval, the historical interval being an interval at which the terminal conducts beam measurement;
or,
the time period corresponds to each of the M time instances is determined based on a future time period, the future time period being a time period during which the terminal conducts beam prediction;
or,
the preset interval between the every two adjacent time instances is determined based on a future interval, the future interval being an interval at which the terminal conducts beam prediction.

In some embodiments, the beam information includes at least one of the following:
reference signal indicator;
beam quality corresponding to the reference signal indicator.

In some embodiments, under the circumstance of the beam information including beam quality corresponding to the reference signal indicator, the beam information includes absolute values of M strongest beam qualities, where the M strongest beam qualities correspond one-to-one to the M time instances, the beam information further includes relative values of the other beam qualities except the strongest beam quality corresponding to the i-th time instance among the M time instances with respect to the strongest beam quality corresponding to the i-th time instance, where i takes integer values from 1 to M;
or,
under the circumstance of the beam information including beam quality corresponding to the reference signal indicator, the beam information includes an absolute value of one strongest beam quality, where the one strongest beam quality corresponds to a target time instance among the M time instances, the beam information further includes relative values of the other beam qualities except the strongest beam quality with respect to the strongest beam quality corresponding to the M time instances.

In some embodiments, the forms of reporting beam information corresponding to the M time instances includes at least one of the following:
non-group-based beam reporting form;
group-based beam reporting form.

In some embodiments, the group-based beam reporting form includes at least one of the following:
reporting two reference signal indicators, where the two reference signal indicators belong to the same group, or belong to two groups, and the two reference signal indicators correspond to two reference signals that a terminal can receive simultaneously;
or,
reporting more than one group, where each group including two reference signal indicators, and the two reference signal indicators within each group correspond to two reference signals that a terminal can receive simultaneously.

In some embodiments, referring to FIG. 10, the apparatus further includes:
receiving module 902, used to receive the configuration information sent by the network device, the configuration information used to configure reference signal measurement resources for beam measurement.

It should be noted that for the device provided in the above-mentioned embodiments to realize its functions, only the division of the above-mentioned functional modules is exemplified. In practical applications, the above-mentioned functions may be assigned to be completed by different functional modules as needed, that is, the internal structure of the device is divided into different functional modules to complete all or part of the functions described above. In addition, the apparatus provided in the above-mentioned embodiments and the method embodiments belong to the same concept. The specific implementation process is detailed in the method embodiments and will not be repeated here.

FIG. 11 is a block diagram showing a beam report receiving apparatus provided by an exemplary embodiment of the present disclosure. Referring to FIG. 11, the apparatus includes:
receiving module 1101, used to receive a beam report sent by a terminal, the beam report including beam information corresponding to M time instances, where M is a positive integer.

In some embodiments, the beam information corresponding to M time instances includes the beam information obtained by the terminal through beam measurement and/or beam information predicted based on a beam prediction model. The beam information predicted based on a beam prediction model is determined by the terminal based on beam information obtained through the beam measurement and the beam prediction model.

In some embodiments, each time instance among the M time instances corresponds to a time period, or the interval between every two adjacent time instances among the M time instances is a preset interval.

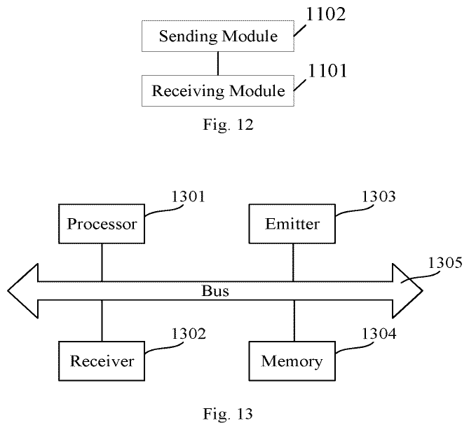

In some embodiments, referring to FIG. 12, the apparatus further includes:
sending module 1102, used to send first indication information to the terminal, the first indication information used to indicate the value of M.

In some embodiments, the receiving module 1101 is further used to receive terminal capability information sent by the terminal, the terminal capability information indicating the maximum number L of time instances included in the beam report supported by the terminal, and M being not greater than L.

In some embodiments, the receiving module 1101 is further used to receive the second indication information sent by the terminal, the second indication information used to indicate the value of M.

In some embodiments, the second indication information is determined by the terminal based on obtained beam information of different time instances.

In some embodiments, the time period corresponding to each of the M time instances is determined based on a historical time period, the historical time period being a time period during which the terminal conducts beam measurement;
or,
the preset interval between the every two adjacent time instances is determined based on a historical interval, the historical interval being an interval at which the terminal conducts beam measurement;
or,
the time period corresponds to each of the M time instances is determined based on a future time period, the future time period being a time period during which the terminal conducts beam prediction;
or,
the preset interval between the every two adjacent time instances is determined based on a future interval, the future interval being an interval at which the terminal conducts beam prediction.

In some embodiments, the beam information includes at least one of the following:
reference signal indicator;
beam quality corresponding to the reference signal indicator.

In some embodiments, under the circumstance of the beam information including beam quality corresponding to the reference signal indicator, the beam information includes absolute values of M strongest beam qualities, where the M strongest beam qualities correspond one-to-one to the M time instances, the beam information further includes relative values of the other beam qualities except the strongest beam quality corresponding to the i-th time instance among the M time instances with respect to the strongest beam quality corresponding to the i-th time instance, where i takes integer values from 1 to M;
or,
under the circumstance of the beam information including beam quality corresponding to the reference signal indicator, the beam information includes an absolute value of one strongest beam quality, where the one strongest beam quality corresponds to a target time instance among the M time instances, the beam information further includes relative values of the other beam qualities except the strongest beam quality with respect to the strongest beam quality corresponding to the M time instances.

In some embodiments, the forms of reporting beam information corresponding to the the M time instances includes at least one of the following:
non-group-based beam reporting form;
group-based beam reporting form.

In some embodiments, the group-based beam reporting form includes at least one of the following:
reporting two reference signal indicators, where the two reference signal indicators belong to the same group, or belong to two groups, and the two reference signal indicators correspond to two reference signals that a terminal can receive simultaneously;
or,
reporting more than one group, where each group including two reference signal indicators, and the two reference signal indicators within each group correspond to two reference signals that a terminal can receive simultaneously.

In some embodiments, the apparatus further includes:
sending module 1102, further used to send configuration information to the terminal, the configuration information used to configure reference signal measurement resources for beam measurement.

It should be noted that for the device provided in the above-mentioned embodiments to realize its functions, only the division of the above-mentioned functional modules is exemplified. In practical applications, the above-mentioned functions may be assigned to be completed by different functional modules as needed, that is, the internal structure of the device is divided into different functional modules to complete all or part of the functions described above. In addition, the apparatus provided in the above-mentioned embodiments and the method embodiments belong to the same concept. The specific implementation process is detailed in the method embodiments and will not be repeated here.

FIG. 13 is a schematic diagram showing a structure of a communication device provided by an exemplary embodiment of the present disclosure. The communication device includes: processor 1301, receiver 1302, emitter 1303, memory 1304 and bus 1305.

The processor 1301 includes one or more processing cores. The processor 1301 executes various functional applications and information processing by running software programs and modules.

The receiver 1302 and the emitter 1303 may be implemented as a communication component, which may be a communication chip.

The memory 1304 is connected to the processor 1301 through the bus 1305.

The memory 1304 may be used to store at least one program code, and the processor 1301 is used to execute the at least one program code to implement each step in the above-mentioned method embodiments.

In addition, the communication device may be a terminal or a network device. The memory 1304 may be implemented by any type of volatile or non-volatile storage device or a combination thereof. Volatile or non-volatile storage devices include but are not limited to: magnetic disks or optical disks, electrically erasable programmable read-only memory (EEPROM), erasable programmable read-only memory (EPROM), static random access memory (SRAM), read-only memory (ROM), magnetic memory, flash memory, programmable read-only memory (PROM).

In some embodiments, for example, there is provided a computer-readable storage medium, executable program codes being stored on the readable storage medium, the executable program codes being loaded and executed to implement a beam report reporting method or a beam report receiving method executed by a communication device provided by each of the embodiments as described in the aspects above.

In some embodiments, for example, there is provided a chip, the chip including programmable logic circuits and/or program instructions, when the chip is run on a terminal or a network device, used to implement a beam report reporting method or a beam report receiving method provided by each of the embodiments as described in the aspects above.

In some embodiments, for example, there is provided a communication system, including a terminal and a network device, the terminal used to implement a beam report reporting method as described above, the network device used to implement a beam report receiving method as described above.

In some embodiments, for example, there is provided a computer program product, and when the computer program product is executed by a processer of a terminal or a network device, it is used to implement a beam report reporting method or a beam report receiving method provided by each of the embodiments as described in the aspects above.

Those skilled in the art may understand that all or part of the steps of the above-mentioned embodiments may be completed by hardware, or may be completed by instructing the relevant hardware through programs. The programs may be stored in a computer-readable storage medium. The above-mentioned storage medium may be a read-only memory, a magnetic disk or an optical disk, etc.

The above content is only optional embodiments of the present disclosure and does not limit this application. Any modification, equivalent replacement, improvement, etc. made within the spirit and principle of the present disclosure should be included within the protection scope of this application.

What is claimed is:

1. A beam report reporting method, the method executed by a terminal, the method comprising:
sending a beam report to a network device, the beam report comprising beam information corresponding to M time instances, wherein M is a positive integer.

2. The method according to claim 1, wherein, the beam information corresponding to M time instances comprises beam information obtained by the terminal through beam measurement and/or beam information predicted based on a beam prediction model, the beam information predicted based on a beam prediction model being determined by the terminal based on beam information through the beam measurement and the beam prediction model.

3. The method according to claim 1 or 2, wherein, each of the M time instances corresponds to a time period, or, an interval between every two adjacent time instances among the M time instances is a preset interval.

4. The method according to claim 3, wherein, the method further comprises:
receiving first indication information sent by the network device, the first indication information used to indicate a value of M.

5. The method according to claim 4, wherein, the method further comprises:
sending terminal capability information to the network device, the terminal capability information indicating a maximum number L of time instances comprised in the beam report supported by the terminal, and M being not greater than L.

6. The method according to claim 3, wherein, the method further comprises:
sending second indication information to the network device, the second indication information used to indicate a value of M.

7. The method according to claim 6, wherein, the second indication information is determined by the terminal based on obtained beam information of different time instances.

8. The method according to any one of claims 3 to 7, wherein, the time period corresponding to each of the M time instances is determined based on a historical time period, the historical time period being a time period during which the terminal conducts beam measurement;
or,
the preset interval between the every two adjacent time instances is determined based on a historical interval, the historical interval being an interval at which the terminal conducts beam measurement;
or,
the time period corresponds to each of the M time instances is determined based on a future time period, the future time period being a time period during which the terminal conducts beam prediction;
or,
the preset interval between the every two adjacent time instances is determined based on a future interval, the future interval being an interval at which the terminal conducts beam prediction.

9. The method according to any one of claims 1 to 8, wherein, the beam information comprises at least one of the following:
reference signal indicator;
beam quality corresponding to the reference signal indicator.

10. The method according to claim 9, wherein, under the circumstance of the beam information comprising beam quality corresponding to the reference signal indicator, the beam information comprises absolute values of M strongest beam qualities, wherein the M strongest beam qualities correspond one-to-one to the M time instances, the beam information further comprises relative values of other beam qualities except the strongest beam quality corresponding to the i-th time instance among the M time instances with respect to the strongest beam quality corresponding to the i-th time instance, wherein i takes integer values from 1 to M;
or,
under the circumstance of the beam information comprising beam quality corresponding to the reference signal indicator, the beam information comprises an absolute value of one strongest beam quality, wherein the one strongest beam quality corresponds to a target time instance among the M time instances, the beam information further comprises relative values of other beam qualities except the strongest beam quality with respect to the strongest beam quality corresponding to the M time instances.

11. The method according to any one of claims 1 to 10, wherein, forms of reporting beam information corresponding to the M time instances comprises at least one of the following:
non-group-based beam reporting form;
group-based beam reporting form.

12. The method according to claim 11, wherein, the group-based beam reporting form comprises at least one of the following:
reporting two reference signal indicators, wherein the two reference signal indicators belong to a same group, or belong to two groups, and the two reference signal indicators correspond to two reference signals that a terminal can receive simultaneously;
or,
reporting more than one group, wherein each group comprising two reference signal indicators, and the two reference signal indicators within each group correspond to two reference signals that a terminal can receive simultaneously.

13. The method according to any one of claims 1 to 12, wherein, the method further comprises:
receiving configuration information sent by the network device, the configuration information used to configure reference signal measurement resources for beam measurement.

14. A beam report receiving method, the method executed by a network device, the method comprising:
receiving a beam report sent by a terminal, the beam report comprising beam information corresponding to M time instances, wherein M is a positive integer.

15. The method according to claim 14, wherein, the beam information corresponding to M time instances comprises beam information obtained by the terminal through beam measurement and/or beam information predicted based on a beam prediction model, the beam information predicted based on a beam prediction model being determined by the terminal based on beam information through the beam measurement and the beam prediction model.

16. The method according to claim 14 or 15, wherein, each of the M time instances corresponds to a time period, or, an interval between every two adjacent time instances among the M time instances is a preset interval.

17. The method according to claim 16, wherein, the method further comprises:
sending first indication information to the terminal, the first indication information used to indicate a value of M.

18. The method according to claim 17, wherein, the method further comprises:
receiving terminal capability information sent by the terminal, the terminal capability information indicating a maximum number L of time instances comprised in the beam report supported by the terminal, and M being not greater than L.

19. The method according to claim 16, wherein, the method further comprises:
receiving second indication information sent by the terminal, the second indication information used to indicate a value of M.

20. The method according to claim 19, wherein, the second indication information is determined by the terminal based on obtained beam information of different time instances.

21. The method according to any one of claims 16 to 20, wherein, the time period corresponds to each of the M time instances is determined based on a historical time period, the historical time period being a time period during which the terminal conducts beam measurement;
or,
the preset interval between the every two adjacent time instances is determined based on a historical interval, the historical interval being an interval at which the terminal conducts beam measurement;
or,
the time period corresponds to each of the M time instances is determined based on a future time period, the future time period being a time period during which the terminal conducts beam prediction;
or,
the preset interval between the every two adjacent time instances is determined based on a future interval, the future interval being an interval at which the terminal conducts beam prediction.

22. The method according to any one of claims 14 to 21, wherein, the beam information comprises at least one of the following:
reference signal indicator;
beam quality corresponding to the reference signal indicator.

23. The method according to claim 22, wherein, under the circumstance of the beam information comprising beam quality corresponding to the reference signal indicator, the beam information comprises absolute values of M strongest beam qualities, wherein the M strongest beam qualities correspond one-to-one to the M time instances, the beam information further comprises relative values of other beam qualities except the strongest beam quality corresponding to the i-th time instance among the M time instances with respect to the strongest beam quality corresponding to the i-th time instance, wherein i takes integer values from 1 to M;
or,
under the circumstance of the beam information comprising beam quality corresponding to the reference signal indicator, the beam information comprises an absolute value of one strongest beam quality, wherein the one strongest beam quality corresponds to a target time instance among the M time instances, the beam information further comprises relative values of other beam qualities except the strongest beam quality with respect to the strongest beam quality corresponding to the M time instances.

24. The method according to any one of claims 14 to 23, wherein, forms of reporting beam information corresponding to the M time points comprises at least one of the following:
non-group-based beam reporting form;
group-based beam reporting form.

25. The method according to claim 24, wherein, the group-based beam reporting form comprises at least one of the following:
reporting two reference signal indicators, wherein the two reference signal indicators belong to a same group, or belong to two groups, and the two reference signal indicators correspond to two reference signals that a terminal can receive simultaneously;
or,
reporting more than one group, wherein each group comprising two reference signal indicators, and the two reference signal indicators within each group correspond to two reference signals that a terminal can receive simultaneously.

26. The method according to any one of claims 14 to 25, wherein, the method further comprises:
sending configuration information to the terminal, the configuration information used to configure reference signal measurement resources for beam measurement.

27. A beam report reporting apparatus, comprising:
sending module, configured to send a beam report to a network device, the beam report comprising beam information corresponding to M time instances, wherein M is a positive integer.

28. A beam report receiving apparatus, comprising:
receiving module, configured to receive a beam report sent by a terminal, the beam report comprising beam information corresponding to M time instances, wherein M is a positive integer.

29. A terminal, comprising:
a processor;
a transceiver connected to the processor;
wherein, the processor is configured to load and execute executable instructions to implement a beam report reporting method according to any one of claims 1 to 13.

30. A network device, comprising:
a processor;
a transceiver connected to the processor;
wherein, the processor is configured to load and execute executable instructions to implement a beam report receiving method according to any one of claims 14 to 26.

31. A communication system, comprising a terminal and a network device, the terminal used to implement a beam report reporting method according to any one of claims 1 to 13, the network device used to implement a beam report receiving method according to any one of claims 14 to 26.

32. A computer-readable storage medium, executable program codes being stored on the readable storage medium, the executable program codes being loaded and executed to implement a beam report reporting method according to any one of claims 1 to 13, or to implement a beam report receiving method according to any one of claims 14 to 26.
